(19) United States
(12) Patent Application Publication
(10) Pub. No.: US 2025/0363531 A1
(43) Pub. Date: Nov. 27, 2025

(54) DYNAMIC ITEM ALLOCATION USING REAL-TIME DATA AND FEEDBACK

(71) Applicant: Lionsoul Global Inc., Austin, TX (US)

(72) Inventors: Alexey Bulavin, London (GB); Jerome Edward Gudgeon, Redhill (GB)

(21) Appl. No.: 19/216,631

(22) Filed: May 22, 2025

Related U.S. Application Data
(60) Provisional application No. 63/651,369, filed on May 23, 2024.

(51) Int. Cl. G06Q 30/0282; G06Q 40/04

(52) U.S. Cl. CPC G06Q 30/0282; G06Q 40/04

(57) ABSTRACT

A computer-implemented platform executes digital-item exchanges by dynamically selecting and interacting with third-party service providers. A service selection module continuously gathers real-time metrics (e.g., API response times, availability, price) and feedback metrics (e.g., error rates, user ratings) for each candidate provider and computes two core scores: an overall score, reflecting provider speed, reliability, and reputation, and a pair score, which further incorporates liquidity and price suitability for a specific digital-item pair. Providers are chosen based on the highest pair score for each exchange request, and if an exchange attempt fails, the module automatically recalculates pair scores and retries the request with the next-best provider, thereby ensuring resilience against performance changes.

### RELATED APPLICATIONS

This application claims the benefit of U.S. Provisional Application No. 63/651,369, filed May 23, 2024, which is incorporated by reference.

### BACKGROUND

### 1. Technical Field

The present disclosure relates generally to computer-implemented platforms for managing digital items via multiple third-party service providers, and more particularly to methods for dynamically selecting an optimal provider based on real-time performance metrics and user feedback to ensure reliable and efficient operations.

### 2. Background Information

Digital item transactions often span multiple third-party service providers, each exposing distinct API formats, communication protocols, and operational characteristics. Critical performance metrics—such as API response times, service availability, and pricing—can fluctuate rapidly, so that a provider handling requests efficiently at one moment may become unavailable or unresponsive the next, leading to failed or delayed exchanges when executed without continuous performance monitoring and adaptation.

Integrating these heterogeneous providers typically requires bespoke adapters that map the platform's native operations into each provider's specific interface format, increasing system complexity and slowing the onboarding of new providers or support for novel digital-item types. Moreover, existing platforms generally lack automated mechanisms to detect failures during transaction execution and seamlessly switch to alternative providers in real time, often necessitating manual intervention or resulting in incomplete exchanges when a selected provider fails to service a request. Consequently, there is a need for a technical solution that continuously monitors provider performance, provides a flexible interaction-layer architecture for varied interfaces, and automatically fails over to alternative providers to ensure reliable and efficient execution of digital item operations.

### SUMMARY

A computer-implemented platform executes digital-item exchanges by dynamically selecting and interacting with third-party service providers. A service selection module continuously gathers real-time metrics (e.g., API response times, availability, price) and feedback metrics (e.g., error rates, user ratings) for each candidate provider and computes two core scores: an overall score, reflecting provider speed, reliability, and reputation, and a pair score, which further incorporates liquidity and price suitability for a specific digital-item pair. Providers are chosen based on the highest pair score for each exchange request, and if an exchange attempt fails, the module automatically recalculates pair scores and retries the request with the next-best provider, thereby ensuring resilience against performance changes.

### BRIEF DESCRIPTION OF THE DRAWINGS

FIG. 1 is a block diagram of a networked computing environment suitable for enabling transactions involving digital assets, according to one embodiment.

FIG. 2 is a block diagram of the digital assets platform shown in FIG. 1, according to one embodiment.

FIG. 3 illustrates implementation of an example strategy using native operations, according to one embodiment.

FIG. 4 is a flowchart of a process for the digital assets platform to implement a transaction by dynamically selecting a third-party provider to perform a service, according to one embodiment.

FIG. 5 is a block diagram illustrating an example of a computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

There is currently significant interest in digital assets such as cryptocurrencies, non-fungible tokens, derivatives and funds involving digital assets, and other decentralized finance (DeFi) assets. However, implementation of such strategies involving such assets is hampered by several technical limitations of existing platforms and services. Crypto exchanges often place limits on volume of trades by individuals. Many platforms do not provide direct ownership of assets and are subject to significant risk of fraud. Some investors opt to directly store their own digital assets, but this is administratively cumbersome and leads to increased risk of theft or other losses of assets. One significant technical problem that arises is that efficient implementation of a digital asset strategy is that availability, response times, and pricing of third-party services or platforms used for obtaining and disposing of digital assets can all rapidly change. Thus, a method of implementing a particular strategy that was efficient in one moment may be inefficient or totally fail in the next. Therefore, pre-existing digital asset platforms cannot automatically provide efficient implementation of desired strategies.

The above and other problems may be addressed by a digital assets platform that dynamically selects third-party platforms and services to implement strategies using real-time data and feedback. When a strategy involves exchanging one asset for another, the digital assets platform uses real-time data, feedback, or both to select a provider to service the request to exchange assets. The real-time data may include metrics such as current exchange rates/prices offered by the providers, availability of the desired asset (e.g., a liquidity depth), current API response times, and the like. The feedback may include metrics such as average API response times, numbers of prior errors, ratings of past interactions, and the like. In one embodiment, the digital assets platform selects a provider based on one or more scores (derived from the real-time data, feedback, or both) associated with a set of candidate providers. The digital assets platform requests the asset exchange with the selected provider, rates the interaction with the selected provider, and updates one or more scores associated with the provider. If the selected provider fails to service the request, the digital assets platform may select a different provider to service the request.

### Example Systems

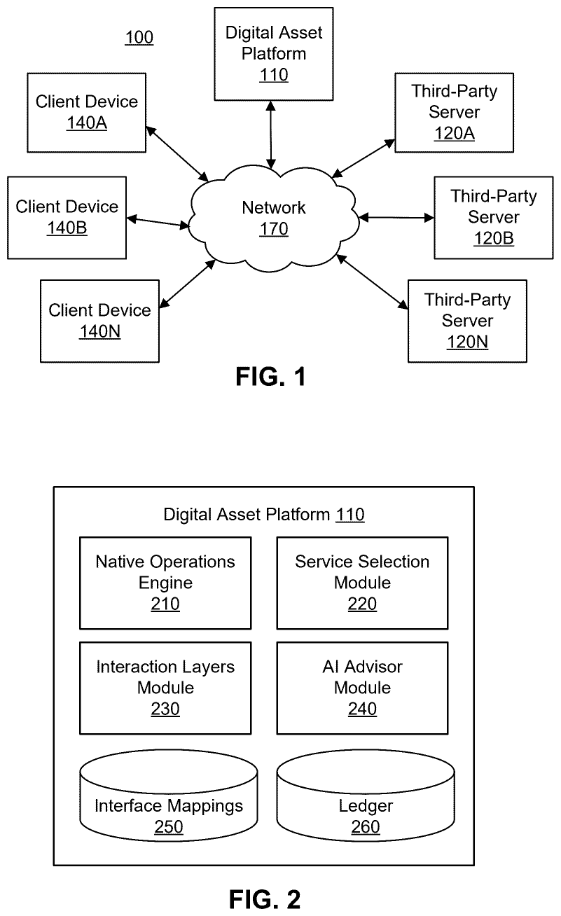

FIG. 1 illustrates one embodiment of a networked computing environment 100 suitable for providing transactions involving digital assets. In the embodiment shown, the networked computing environment 100 includes a digital assets platform 110, one or more third-party servers 120A-N, and one or more client devices 140A-N, all connected via a network 170. In other embodiments, the networked computing environment 100 includes different or additional elements. In addition, the functions may be distributed among the elements in a different manner than described.

The digital assets platform 110 enables users to manage portfolios of digital assets. Users may deposit digital assets into the ecosystem managed by the digital assets platform. The digital assets platform 110 can serve as an interface for the custodial wallets of users, which can accept deposits in a variety of digital assets and fiat currencies. The digital assets platform uses a transaction processing engine that can enable users to place “multi-asset” or “multi-currency” investments, maximizing the tax benefits associated with in-kind contributions to both SMA and private fund products. In some configurations, users may also acquire digital assets provided natively in the ecosystem (e.g., by providing fiat currency in exchange for tokens of a cryptocurrency provided by the digital assets platform).

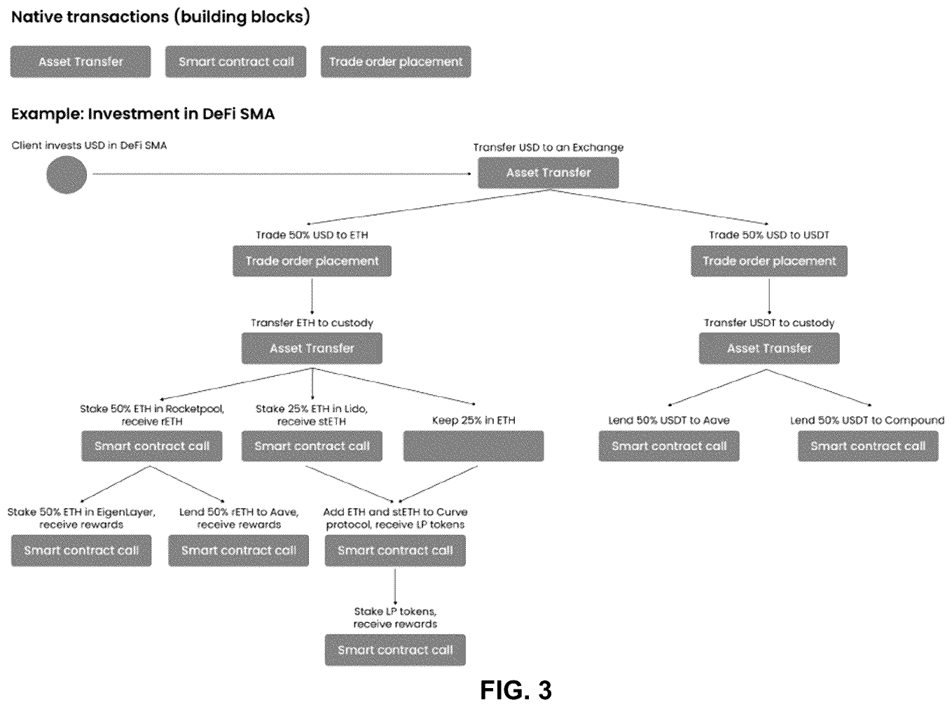

In one embodiment, the digital assets platform 110 may enable users to implement various investment strategies using one or more of a set of native operations. The implemented strategies may involve operations that are implemented within the digital assets platform 110, operations in which digital assets platform causes third-party servers 120 to provide services by mapping one or more native operations to a format used by a third-party server 120, or a combination of both. Various embodiments of the digital assets platform 110 and approaches to mapping native operations to formats used by third-party servers 120 are described in greater detail below, with reference to FIGS. 2 and 3.

A third-party server 120 is one or more computing devices that provide digital asset services, such as exchanges, DeFi protocols, or custodial services, etc. Although three third-party servers 120A, 120B & 120N are shown the networked computing environment 100 may include any number of such servers. In one embodiment, each third-party server 120 receives requests for services and provides the results of processing those requests using its own operation format that is different from the format of the native operations. For example, a third-party server 120 may provide an API with a set of functions via which the digital assets platform 110 (and other devices) may access one or more services provided by the third-party server 120. At any given point, the response times, likelihood of failure, and price or cost associated with the servicing of requests sent to third-party servers 120 may depend on a range of factors, such as demand levels, hardware outages, market conditions, and liquidity depths, etc.

A client device 140 is a computing device with which users interact with the digital assets platform 110. Although three client devices 140A, 140B & 140N are shown, the networked computing environment 100 can include any number of such devices. In one embodiment, a client device 140 provides a user interface (e.g., within a dedicated application or via a webpage hosted by the digital assets platform accessed via a browser) with which the user can deposit and withdraw digital assets or fiat currency into or out of the digital assets platform 110, respectively. The user may also use the user interface to select investment strategies for deposited assets. For example, the user may deposit or purchase cryptocurrency and assign the cryptocurrency to one or more separately managed accounts (SMAs), native funds, third-party funds, or any other investment strategies provided by the digital assets platform 110. The user interface 140 may also include a dashboard or similar interface via which the user can monitor performance of their investments and access other information about their portfolio of digital assets.

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

FIG. 2 illustrates one embodiment of the digital assets platform 110. In the embodiment shown, the digital assets platform 110 includes a native operations engine 210, a service selection module 220, an interaction layers module 230, an AI advisor module 240, interface mappings 250, and a ledger 260. In other embodiments, the digital assets platform 110 includes different or additional elements. In addition, the functions may be distributed among the elements in a different manner than described.

The native operations engine 210 provides a set of native operations, which are fundamental operations such as asset transfers, smart contract executions, and trade order placements. These native operations can be chained together to create complex transactional chains to implement a wide range of investment strategies and transactions. In one embodiment, the interactions that can be implemented using native operations include: investments, redemptions, withdrawals, portfolio rebalancing, staking Etherium (ETH) (e.g., using the Lido or Rocketpool staking protocols), restaking ETH (e.g., using the EigenLayer staking protocol), lending restaked ETH (e.g., using the Aave or Compound lending protocols), and providing restaked ETH to a liquidity pool, etc. Using chains of operations with these (or similar third-party service providers) can provide integrity and reliable execution of complex financial actions.

For example, FIG. 3 illustrates an example strategy for a SMA that may be implemented using native operations. Implementing the set of native operations involves using numerous services provided by third-party server 110. For example, converting a portion of the user's deposited fiat currency (in this case USD) to ETH involves placing a trade order with an exchange. For any given service, there may be multiple third-party servers 120 that can provide the desired service (or there may be a choice between providing the service within the digital assets platform or using one or more third-party servers 120). The service selection module 220 selects which entity will be used to provide the service at the time the service is requested by a native operation.

The service selection module 220 obtains data regarding candidate service providers and selects which provider to use based on the retrieved data. The data may include real-time or close to real-time data regarding services provided by the candidate service providers, feedback regarding prior services provided by the candidate service providers, or both. The real-time (or close to real-time) data for a candidate service provider may include one or more of a cost for providing the service, an exchange or other rate provided for the service, a predicted time for the provider to complete the service (e.g., a currently reported API response time), or an availability of the desired asset from the provider (e.g., a liquidity depth). The feedback regarding prior services provided by the candidate service provider may include one or more of a probability of the provider being unable to service the request, an error rate, an average response time (e.g., an average API response time), ratings of prior interactions provided by the current user (e.g., an average rating provided by the user), or ratings of prior interactions provided by other users (e.g., an average of ratings provided by all users or a subset of users identified as similar to the current user or making a similar request to the current request). In some embodiments, selecting of the service provider may also include consideration of user preferences.

In various embodiments, the service selection module 220 calculates a set of metrics for candidate service providers using the retrieved data. The metrics are used for selection of which service provider to use for any given request. The metrics may include an overall score for each provider and a set of pair scores for each provider, with each pair score representing the effectiveness of that provider servicing a request to exchange a first type of asset for a second type of asset. For example, a service provider may have a first pair score for buying ETH with USD, a second pair score for buying Bitcoin (BTC) with USD, a third pair score for exchanging BTC for ETH, etc.

In one embodiment, the overall score for a provider may be calculated as:

Overall Score=w1*Speed Score+w2*(1/Error Score)+w3*Feedback Score

where w1, w2, and w3 are weights, the Speed Score is a metric representing the average response time of the provider in servicing requests (e.g., an average API response time), the Error Score is a metric based on the number of service failures (e.g., API failures), such as a total number of failures or a percentage of requests that fail, and the Feedback Score is a metric derived from feedback provided regarding past interactions with the service provider. For example, the service selection module 220 may provide a rating from zero to ten for each interaction, with the Feedback Score being a mean, median, or other amalgamation of all of the received ratings. The weightings may be set by the operator of the digital assets platform or by the user to tailor the importance of speed, likelihood of failures, and reputation of the provider as desired.

In some instances, the contribution of ratings to the feedback score may be weighted by time such that more recent ratings have a higher impact on the feedback score than older ratings. Additionally or alternatively, the ratings may be subject to a time threshold such that the feedback score is calculated from ratings provided in a given time period (e.g., the last week or month, etc.) or a set number of interactions (e.g., the last 100 or 1000 interactions, etc.).

A pair score for a given provider and pair of assets may be calculated as:

Pair Score=w1′*Overall Score+w2′*Liquidity Depth Score+w3′*Price Score

where w1′, w2′, and w3′ are weights, the Overall Score is the score calculated for the provider as described previously, the Liquidity Depth Score is a metric indicating the amount of the pair of assets the provider is able to trade, and the Price Score is a metric indicating the cost or price currently offered by the given provider relative to other candidate providers. The weightings may be set by the operator of the digital assets platform or by the user to tailor the importance of the overall reputability of the provider's services (as indicated by the Overall Score), the availability of assets from the provider (as indicated by the Liquidity Depth Score), and the price offered by the provider (as indicated by the Price Score). Thus, the pair score may be viewed as a measure of suitability of the service provider to service an exchange between the pair of assets.

Regardless of precisely how they are calculated, the service selection module 220 selects a service provider to process a service request based on the calculated metrics. In one embodiment, the service selection module 220 initially selects the service provider with the highest pair score for a desired trade, attempts to the implement the trade using the selected service provider, and, if the trade fails for any reason, reattempts the trade with a different service provider (e.g., the service provider with the second highest pair score, or a service provider with the highest pair score after recalculating the pair scores to account for the previous failed attempt and any changes in market conditions such as price changes).

The interaction layers module 230 determines how to request desired services from selected providers. Specifically, the interaction layers module 230 provides interaction layers that map operations defined in the native format to the APIs or other interfaces provided by different service providers. In one embodiment, the interaction layers module 230 accesses a mapping for the selected service provider (e.g., by querying a database of interface mappings 250 stored in one or more computer-readable media). The mapping converts the operation as defined in the native format to the format used by the selected service provider. The interaction layers module 230 can thus use the combination of the operation in the native format and the mapping to interact with a third-party server 120 of the selected provider to implement the desired service (e.g., placing on order on an exchange, staking a cryptocurrency with a smart contract call, lending a cryptocurrency with a smart contract call, etc.).

Using the combination of the native operations and the mappings, the digital assets platform can provide flexible creation, removal, and modification of model portfolios (e.g., predefined allocations of assets within a SMA) and fund investment strategies (where the platform acts as an interface for subscriptions in and withdrawals from funds). The use of native operations and mappings also enables flexible connectivity with new DeFi platforms and protocols by simply providing the appropriate mapping between the native operations and the format used by the new platform of protocol. Similarly, the types of assets that may be deposited into and withdrawn from the platform can be easily managed with modifications to the native operations available (e.g., a new type of asset may be accepted for deposit by adding a native operation that defines how that type of asset is injected into the platform). Furthermore, because the services used are selected at the time operations are performed, execution strategies may be optimized (e.g., using different exchanges for transactions using different types of assets as part of implementation of a larger strategy) for a wide range of parameters (e.g., minimizing transaction costs, minimizing implementation time, minimizing tax exposure, etc.).

The AI advisor module 240 can provide dynamic recommendations to users regarding available products and investment strategies. In one embodiment, the AI advisor module 240 asks a user a set of initial questions regarding their goals and preferences and provides one or more recommendations for products or strategies. The AI advisor module 240 may be driven by a trained machine-learning model based on product/strategy selections made by previous users who provided similar answers to the current user in response to the questions. The AI advisor module 240 may additionally or alternatively consider other information about the user, such as information provided in a user profile, prior selections made by the user, and one or more metrics indicating current market conditions.

The ledger 260 includes one or more non-transitory computer-readable media that store a record of assets held by users and transactions made within the digital assets platform 110. In one embodiment, assets are initially labelled as deposited assets when injected into the digital assets platform 110. If the user elects to allocate assets to a SMA, ownership/custody of those assets is not modified in the ledger 260, but the ledger 260 is updated to label the assets as assigned to the SMA. Conversely, if the user elects to invest assets in a fund, those assets are relabeled as deposited assets (if they had been previously assigned to a SMA and labeled accordingly) and a trade order is placed to transfer the assets from the user's custody to a custodial account of the fund. The ledger 260 may maintain a record of a user's investments in funds or the digital assets platform 260 may retrieve information about a user's investments from the fund as needed (e.g., by querying an API the fund).

### Example Methods

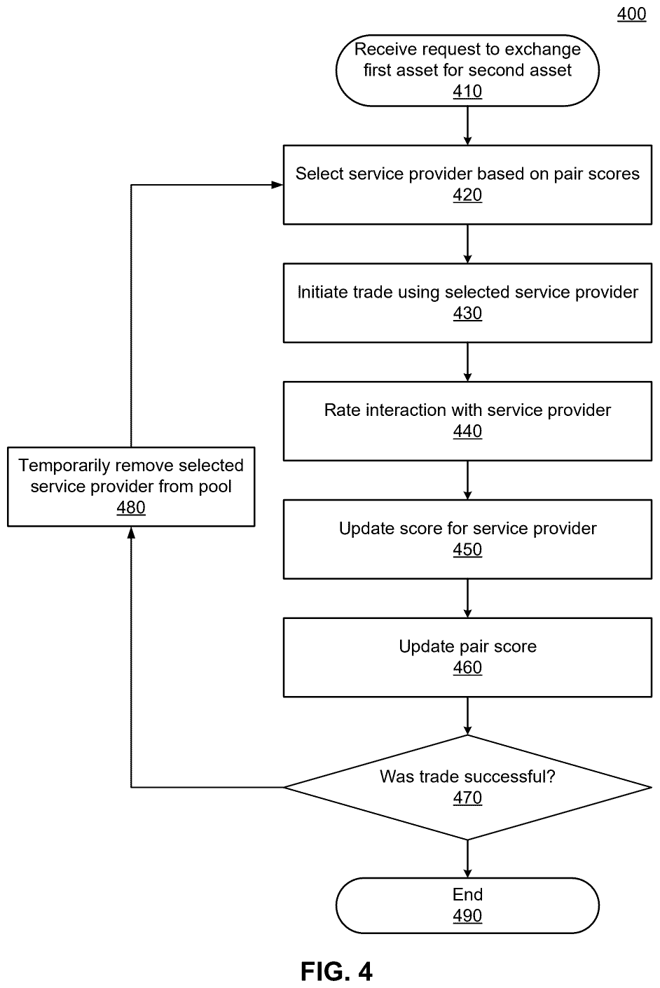

FIG. 4 illustrates a method 400 for implementing a transaction by dynamically selecting a third-party provider to perform a service, according to one embodiment. The steps of FIG. 4 are illustrated from the perspective of the digital assets platform 110 performing the method 400. However, some or all of the steps may be performed by other entities or components. In addition, some embodiments may perform the steps in parallel, perform the steps in different orders, or perform different steps.

In the embodiment shown, the method 400 begins with the digital assets platform 110 receiving 410 a request to exchange a first asset for a second asset. For example, the request may be to purchase a specified amount of ETH with USD. The digital assets platform 110 selects 420 a service provider from a set of candidate service providers using the corresponding pair scores. For example, the digital assets platform 110 may retrieve a list of all candidate service providers that will provide the second asset (e.g., ETH) in exchange for the first (e.g., USD) and the current pair scores for each of those candidate service providers. The digital assets platform 110 may then select 420 one of the candidate service providers based on the pair scores (e.g., the provider with the highest pair score).

Once a service provider has been selected 420, the digital assets platform 110 initiates 430 a trade exchanging the second asset for the first asset with the service provider and rates 440 the interaction with the service provider. For example, the rating may be a score between zero and ten, with zero indicating the transaction failed, ten indicating the transaction was entirely completed in less than a threshold time, and scores in between indicating the transaction took longer than the threshold time (with lower scores generally indicating greater times for the transaction to be complete), that the transaction was only partially completed (e.g., less than the amount of the second asset requested was provided, with lower scores generally indicating lesser proportions of the requested asset being provided), or a combination of both. It should be appreciated that a wide range of factors may be considered in providing a rating for the transaction.

The digital assets platform 110 updates 450 the overall score of the service provider based on the rating and then updates 460 the pair scores for the service provider based on the updated overall score (and, in some embodiments, the rating). The digital assets platform 110 determines 470 whether the trade was successful. If so, the method 400 ends 490. Conversely, if the trade failed, then the selected service provider is temporarily removed 480 from the pool of candidate service providers and a new candidate service provider is selected 420 based on the pair scores. This process may repeat until the trade is successfully completed.

### Computing System Architecture

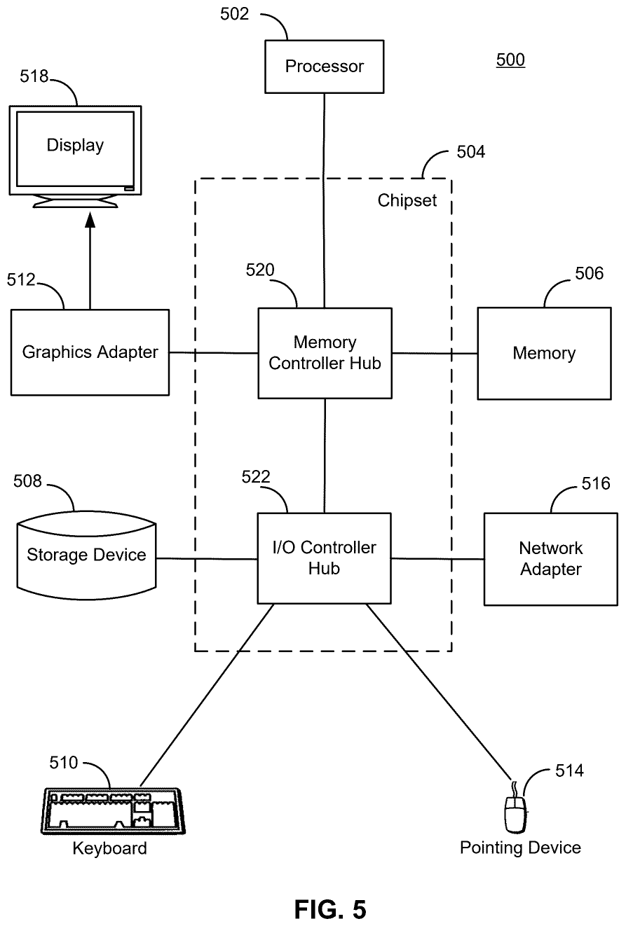

FIG. 5 is a block diagram of an example computer 500 suitable for use within the networked computing environment 100. The example computer 500 includes at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display 518 is coupled to the graphics adapter 512. A storage device 508, keyboard 510, pointing device 514, and network adapter 516 are coupled to the I/O controller hub 522. Other embodiments of the computer 500 have different architectures.

In the embodiment shown in FIG. 5, the storage device 508 is a non-transitory computer-readable storage medium such as a hard drive, compact disk read-only memory (CD-ROM), DVD, or a solid-state memory device. The memory 506 holds instructions and data used by the processor 502. The pointing device 514 is a mouse, track ball, touch-screen, or other type of pointing device, and may be used in combination with the keyboard 510 (which may be an on-screen keyboard) to input data into the computer system 500. The graphics adapter 512 displays images and other information on the display 518. The network adapter 516 couples the computer system 500 to one or more computer networks, such as network 170.

The types of computers used by the entities of FIGS. 1 and 2 can vary depending upon the embodiment and the processing power required by the entity. For example, the digital assets platform 110 might include multiple blade servers working together to provide the functionality described while a client device 140 might be a smartphone or tablet, etc. Furthermore, the computers can lack some of the components described above, such as keyboards 510, graphics adapters 512, and displays 518.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
receiving a request to transfer a digital item from a first user storage location to a second user storage location;
selecting a service provider from a set of service providers based on pair scores, each pair score indicating a suitability of a corresponding service provider to implement the transfer of the digital item from the first user storage location to the second user storage location;
initiating a transfer of the digital item from the first user storage location to the second user storage location with the selected service provider;
obtaining a rating for the selected service provider relating to the transfer; and
updating the pair score corresponding to the selected service provider based on the rating.

2. The computer-implemented method of claim 1, wherein updating the pair score comprises:
updating an overall score for the selected service provider based on the rating; and
updating the pair score based on the updated overall score.

3. The computer-implemented method of claim 2, wherein updating the overall score for a service provider comprises:
computing a feedback score for the service provider based on ratings provided by users for the service provider, wherein more recent ratings are weighted more heavily than older ratings.

4. The computer-implemented method of claim 2, wherein updating the overall score for a service provider comprises:
computing a speed score for the service provider based on an average response time of the service provider in servicing requests.

5. The computer-implemented method of claim 2, wherein updating the overall score for a service provider comprises:
computing an error score for the service provider based on a number or percentage of failed service requests for the service provider.

6. The computer-implemented method of claim 1, further comprising:
receiving a notification that the transfer failed;
removing the selected service provider from the set of service providers;
selecting a second service provider from the set of service providers based on the pair scores; and
initiating a transfer of the digital item from the first user storage location to the second user storage location with the second service provider.

7. The computer-implemented method of claim 6, further comprising:
readding the selected service provider to the set of service providers after a threshold period of time.

8. A non-transitory computer-readable medium storing instructions that, when executed by a computing system, cause the computing system to perform operations comprising:
receiving a request to transfer a digital item from a first user storage location to a second user storage location;
selecting a service provider from a set of service providers based on pair scores, each pair score indicating a suitability of a corresponding service provider to implement the transfer of the digital item from the first user storage location to the second user storage location;
initiating a transfer of the digital item from the first user storage location to the second user storage location with the selected service provider;
obtaining a rating for the selected service provider relating to the transfer; and
updating the pair score corresponding to the selected service provider based on the rating.

9. The computer-readable medium of claim 8, wherein updating the pair score comprises:
updating an overall score for the selected service provider based on the rating; and
updating the pair score based on the updated overall score.

10. The computer-readable medium of claim 9, wherein updating the overall score for a service provider comprises:
computing a feedback score for the service provider based on ratings provided by users for the service provider, wherein more recent ratings are weighted more heavily than older ratings.

11. The computer-readable medium of claim 9, wherein updating the overall score for a service provider comprises:
computing a speed score for the service provider based on an average response time of the service provider in servicing requests.

12. The computer-readable medium of claim 9, wherein updating the overall score for a service provider comprises:
computing an error score for the service provider based on a number or percentage of failed service requests for the service provider.

13. The computer-readable medium of claim 8, the instructions further comprising:
receiving a notification that the transfer failed;
removing the selected service provider from the set of service providers;
selecting a second service provider from the set of service providers based on the pair scores; and
initiating a transfer of the digital item from the first user storage location to the second user storage location with the second service provider.

14. The computer-readable medium of claim 13, the instructions further comprising:
readding the selected service provider to the set of service providers after a threshold period of time.

15. A computing system comprising:
a processor; and
a non-transitory computer-readable medium storing instructions that, when executed by a computing system, cause the computing system to perform operations comprising:
receiving a request to transfer a digital item from a first user storage location to a second user storage location;
selecting a service provider from a set of service providers based on pair scores, each pair score indicating a suitability of a corresponding service provider to implement the transfer of the digital item from the first user storage location to the second user storage location;
initiating a transfer of the digital item from the first user storage location to the second user storage location with the selected service provider;
obtaining a rating for the selected service provider relating to the transfer; and
updating the pair score corresponding to the selected service provider based on the rating.

16. The computing system of claim 15, wherein updating the pair score comprises:
updating an overall score for the selected service provider based on the rating; and
updating the pair score based on the updated overall score.

17. The computing system of claim 16, wherein updating the overall score for a service provider comprises:
computing a feedback score for the service provider based on ratings provided by users for the service provider, wherein more recent ratings are weighted more heavily than older ratings.

18. The computing system of claim 16, wherein updating the overall score for a service provider comprises:
computing a speed score for the service provider based on an average response time of the service provider in servicing requests.

19. The computing system of claim 16, wherein updating the overall score for a service provider comprises:
computing an error score for the service provider based on a number or percentage of failed service requests for the service provider.

20. The computing system of claim 15, the instructions further comprising:
receiving a notification that the transfer failed;
removing the selected service provider from the set of service providers;
selecting a second service provider from the set of service providers based on the pair scores; and
initiating a transfer of the digital item from the first user storage location to the second user storage location with the second service provider.
